(19) United States
(12) Patent Application Publication
(10) Pub. No.: US 2009/0279725 A1
(43) Pub. Date: Nov. 12, 2009

(54) RADIO WITH HEARING LOSS COMPENSATION

(75) Inventor: Douglas E. Leeper, JR., Molalla, OR (US)

Correspondence Address: GARMIN INTERNATIONAL, INC.;ATTN: Legal - IP, 1200 EAST 151ST STREET, OLATHE, KS, 66062, US

(73) Assignee: GARMIN INTERNATIONAL, INC., Olathe, KS (US)

(21) Appl. No.: 12/116,833

(22) Filed: May 7, 2008

(51) Int. Cl. H04R 25/00

(52) U.S. Cl. 381/314

(57) ABSTRACT

A radio receiving system to compensate for hearing loss comprises a receiver, a sound reproduction device, and a hearing loss compensator. The receiver is generally located in the cockpit of an aircraft. The receiver receives radio frequency transmissions and converts the transmissions into audio frequency electrical signals. The sound reproduction device converts audio frequency electrical signals into audible sounds and generally includes one or two speakers to be positioned in close proximity to a pilot's ears. The hearing loss compensator provides audio frequency electrical signal gain at a plurality of frequencies and may include programmable electrical circuitry and memory elements. The programmable electrical circuitry may adjust the electrical signal gain at each of the plurality of frequencies and the memory elements may store settings for the gain at each of the plurality of frequencies. Settings for various age groups, gender-specific settings, or individual pilot settings may be stored in the memory elements.

### BACKGROUND OF THE INVENTION

Embodiments of the present invention relate to radios, such as aircraft communication radios. More particularly, embodiments of the present invention relate to aircraft communication radios that provide hearing loss compensation.

Airline workers, such as pilots and other aircraft cockpit personnel, are often exposed to noisy environments which can lead to increased hearing loss over time. Cockpit communications headsets generally interfere with the operation of standard hearing aids, often causing the hearing aid to squeal, or otherwise experience diminished performance, when in the presence of the headset earpieces. Thus, it is often difficult for pilots as well as other crew members, passengers, and the like, to hear in aircraft cockpit environments.

### SUMMARY OF THE INVENTION

Embodiments of the present invention provide a distinct advance in the art of cockpit communication radios. More particularly, embodiments of the invention provide a cockpit communication radio system that provides hearing loss compensation.

In various embodiments, the system comprises a receiver, a sound reproduction device, and a hearing loss compensator. The receiver is generally located in the cockpit or equipment bay of an aircraft. The receiver receives radio frequency transmissions and converts the transmissions into audio frequency electrical signals. The sound reproduction device converts audio frequency electrical signals into audible sounds and generally includes one or two speakers to be positioned in close proximity to a pilot's ears. The hearing loss compensator, coupled with the receiver, provides audio frequency electrical signal gain at a plurality of frequencies and may include programmable electrical circuitry and memory elements. The programmable electrical circuitry may adjust the electrical signal gain at each of the plurality of frequencies and the memory elements may store settings for the gain at each of the plurality of frequencies. Settings for various age groups, gender-specific settings, or individual pilot and passenger settings may be stored in the memory elements.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention is described in detail below with reference to the attached drawing figures, wherein:

FIG. 1 is a graph showing hearing loss at various ages for typical males and females;

FIG. 2 is a schematic view of an aircraft cockpit showing a radio receiving system constructed in accordance with various embodiments of the current invention;

FIG. 3 is a block diagram showing an embodiment of the radio receiving system;

FIG. 4 is a schematic view of an airport environment showing an air traffic control tower;

FIG. 5 is a block diagram of a hearing loss compensator of a radio receiving system;

FIG. 6 is a block diagram showing another embodiment of the radio receiving system;

FIG. 7 is a block diagram showing yet another embodiment of the radio receiving system; and

FIG. 8 is a flow diagram depicting some of the steps performed in a method of compensating for hearing loss in an aircraft cockpit environment.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

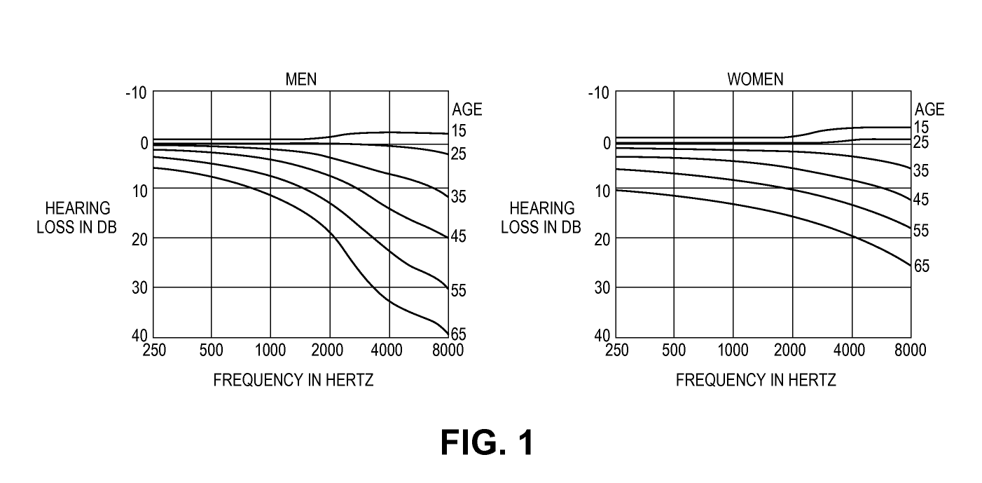

Hearing loss in the average human is shown in the frequency response graphs of FIG. 1. The graphs show hearing loss measured in decibels (dB) as a function of audio frequency with multiple plots for various ages from 15 to 65 years old. The graphs show that after a certain age (approximately 20 for men and approximately 26 for women) hearing loss increases at higher frequencies and at older age—particularly so for men. For example, a typical 55-year old man has a hearing loss of approximately 12 dB at 2000 Hertz (Hz). Thus, sounds at that frequency seem about 1/16th as loud as they do to someone with no hearing loss. Likewise, a typical 55-year old woman has a hearing loss of approximately 10 dB at 2000 Hz. Hence, sounds at that frequency seem about 1/10^{th} as loud as they do to someone with no hearing loss.

The data presented in these graphs is merely exemplary of the hearing loss problem, various factors, such as exposure to excessive sound levels for long periods of time, can influence the amount of sound loss a person experiences. For example, a person who spends most of his or her time in a generally quiet environment will likely have a much lower amount of hearing loss than is shown in the graphs of FIG. 1. Alternatively, even though a pilot may wear hearing protection, he or she may experience hearing loss greater than that shown in the graphs of FIG. 1.

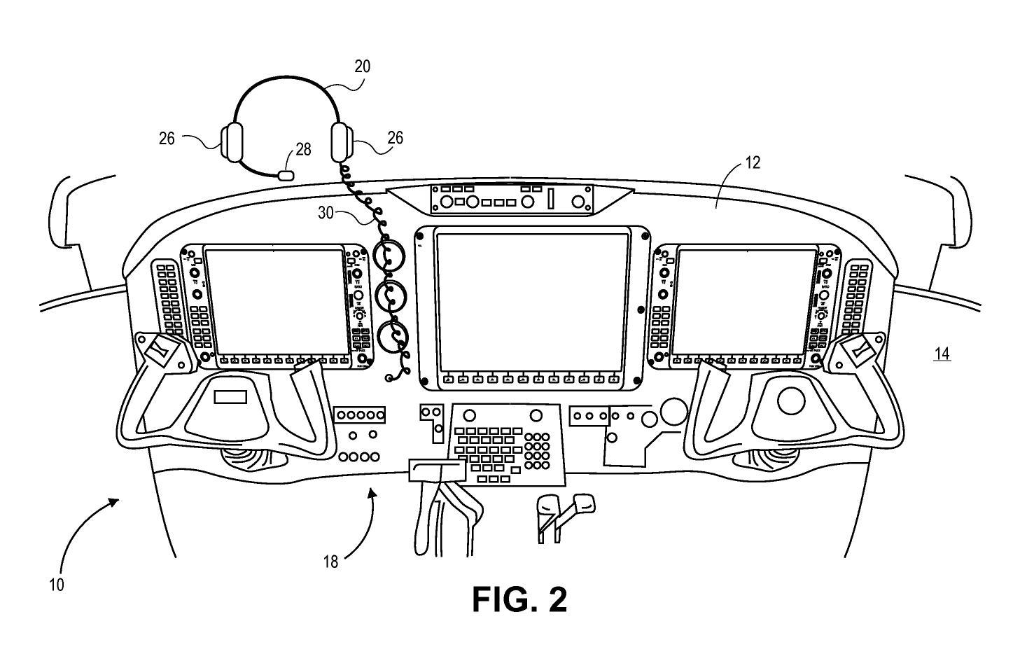

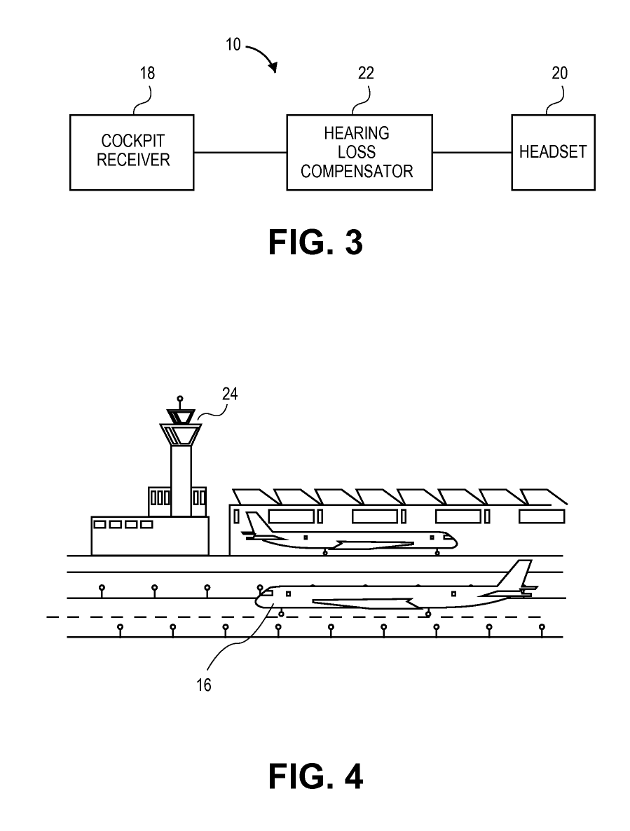

A radio receiving system 10 as constructed in accordance with various embodiments of the present invention is shown in FIG. 2. The radio receiving system 10 may be located in a console 12 of an aircraft cockpit 14, comprise a portion of an integrated avionics suite such as the Garmin® G1000®, and/or comprise a portion of a panel mount system such as the Garmin® GNC® 250XL. Portions of the radio receiving system 10 may also be located in an equipment or electronics bay, or other areas of an aircraft. As shown in FIG. 3, the radio receiving system 10 comprises a receiver 18, a sound reproduction device 20, and a hearing loss compensator 22.

The receiver 18, which may be located in an equipment or electronics bay, or other areas of an aircraft, may receive radio frequency (RF) communications from a transmitter, such as an air traffic control tower 24, other aircraft 16, as shown in FIG. 4, and/or Federal Aviation Administration (FAA) stations, or other radio source stations. The range of frequencies for air traffic control may be between approximately 118 MegaHertz (MHz) and approximately 135.975 MHz. However, the receiver 18 may receive transmissions at other frequencies as well. The receiver generally converts the RF communications into audio frequency electrical signals. The audio frequency spectrum generally includes frequencies of approximately 20 Hz to approximately 20,000 Hz. The receiver may be capable of demodulating standard frequency-modulated (FM) signals as well as other types of RF signal encoding. The receiver 18 may include RF-associated electrical components such as antennas, tuners, amplifiers, filters, readouts, displays, and speakers. The receiver may include analog electronics, digital electronics, or a combination of both, as well as electrical components such as microprocessors, microcontrollers, or digital signal processors.

The sound reproduction device 20 generally converts audio frequency electrical signals into audible sound, usually within the audio frequency spectrum range listed above. The sound reproduction device 20 may include a headset that is typically worn on a person's head and includes at least one speaker 26 that aligns with the person's ear when the sound reproduction device 20 is worn. Often, the sound reproduction device 20 includes two speakers 26 that align with both ears. Furthermore, the sound reproduction devices 20 may have the two speakers 26 and a boom mounted microphone 28, as seen in FIG. 2, that aligns with a person's mouth. The speakers 26 of the sound reproduction device 20 may include full-range drivers, with moving-coil, electrostatic, balanced armature, or other transductive elements. The sound reproduction device 20 may also include a cable 30, as seen in FIG. 2, which may couple to an audio component, such as the receiver 18, through which the sound reproduction device 20 may receive audio frequency electrical signals. The sound reproduction device 20 may also be capable of receiving audio frequency electrical signals wirelessly, such as with a Bluetooth™ receiver or other wireless audio standard system. In such an embodiment, the sound reproduction device 20 may also include wireless receiving components to properly convert the wireless signals to audio frequency electrical signals to be forwarded to the speaker 26.

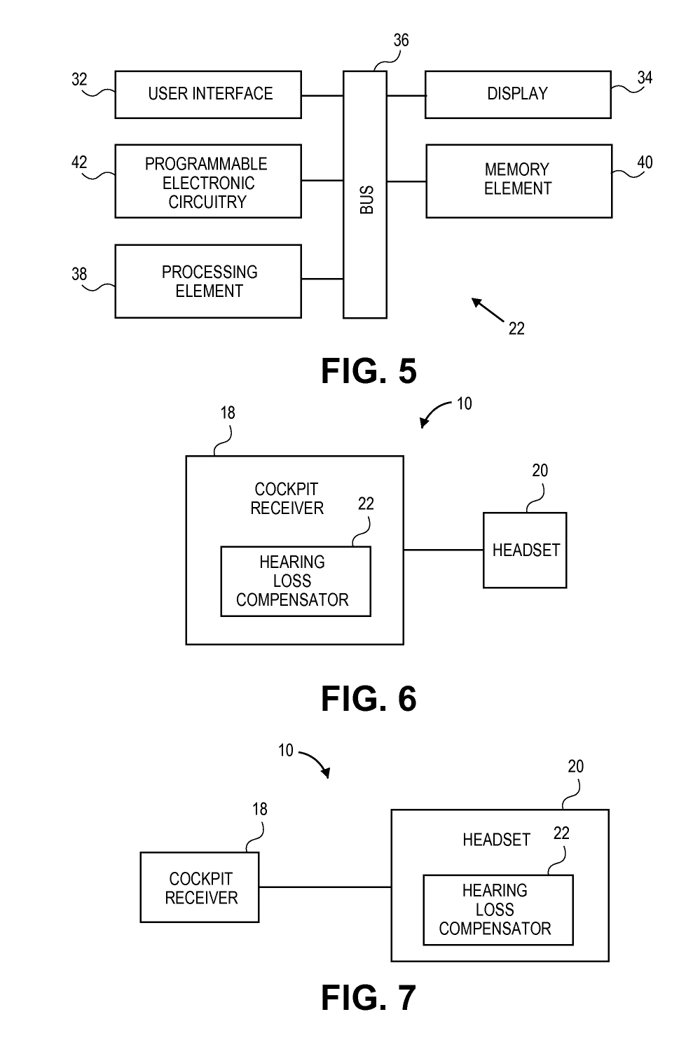

The hearing loss compensator 22 provides electrical signal gain at a plurality of frequencies in the audible spectrum. Various embodiments of the hearing loss compensator 22, as shown in FIG. 5, include a user interface 32, a display 34, a bus 36, a processing element 38, a memory element 40, and programmable electrical circuitry 42.

The user interface 32 may allow the pilot to interact with the hearing loss compensator 22, and may include an alphanumeric keypad or keyboard, a touch-input device integrated with or separate from the display 34 (e.g., a touchscreen), a trackball, buttons, switches, sliders, knobs, or the like. The user interface 32 may employ a microphone such as the sound reproduction device microphone (or a second microphone) and audio decoding circuitry to decode voice instructions from the pilot. Furthermore, the user interface 32 may comprise card readers, wired or wireless data transfer elements such as data ports, e.g. universal serial bus (USB), or removable memory, including the memory element 40, to enable the pilot and other devices or parties to remotely interface with the hearing loss compensator 22. The user interface 32 may be coupled with the bus 36 and all input from the pilot may be forwarded to the appropriate component of the hearing loss compensator 22 through the bus 36.

The display 34 generally displays information to the pilot, such information including status of power and functional components, current settings of functional components, audio spectrum output, audio spectrum settings, data from the user interface 32, and the like. The display 34 may comprise one or more individual light-emitting diodes (LEDs), one or more multi-segment (e.g. 7-segment) LEDs, color display elements (or alternatively, black and white or monochrome display elements) including, but not limited to, LCD (Liquid Crystal Diode), TFT (Thin Film Transistor) LCD, LEP (Light Emitting Polymer) or PLED (Polymer LED), and/or plasma display devices. The display 34 is generally of sufficient size to enable the pilot to easily view the display 34 to receive presented information while in transit.

The bus 36 generally acts as an interface between the components of the hearing loss compensator 22. The bus 36 may transfer data from one component to another. For example, through the bus 36, the memory element 40 may transfer programming information to the programmable electrical circuitry 42 or may transfer setting information to the display 34. The bus 36 may also transfer control information from one component to another. For example, the processing element 38 may send a control signal through the bus 36 to the memory element 40 to initiate a data transfer. Some portions of the bus 36 may include single-bit serial lines, other portions may include multi-bit parallel lines, and some segments of the bus 36 may include both serial and parallel implementations. The bus 36 may include metal conductor wires, cables, or printed circuit board (PCB) traces, or combinations thereof. The bus 36 may also include optical fiber cables, bundles, or other optical or electrical waveguides, or combinations thereof.

The processing element 38 may control the operation of the hearing loss compensator 22 by directing the transfer of data and control signals from one component to another and controlling the timing of various events in the hearing loss compensator 22. For example, based on user input, the processing element 38 may initiate a transfer of programming settings from the memory element 40 to the programmable electrical circuitry 42.

The processing element 38 may implement a computer program which performs some of the functions described herein. In various embodiments, the computer program comprises an ordered listing of executable instructions for implementing logical functions in the processing system. The computer program can be embodied in any computer-readable medium for use by or in connection with an instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a random access memory (RAM), a read-only memory (ROM), an erasable, programmable, read-only memory (EPROM or Flash memory), a portable computer diskette, and a portable compact disk read-only memory (CDROM).

The processing element 38 may include microprocessors, microcontrollers, programmable intelligent computers (PICs), or the like. The processing element 38 may also include field-programmable gate arrays (FPGAs), or other programmable logic devices (PLDs), fully-custom or semi-custom application-specific integrated circuits (ASICs), or any other device that is described by one or more code segments of a hardware description language (HDL). Further, the processing element 38 may include combinations of any of the components listed.

The memory element 40 generally stores information for the operation of the hearing loss compensator 22. The memory element 40 may store programming information for one or more individual pilot, crew such as a co-pilot, flight engineer, ground crew, flight attendant, and the like or passengers, groups of pilots or passengers based on age and/or gender, or customized programming settings that may be entered in real time, as the pilot or passengers want to make small adjustments. The memory element 40 may include, for example, removable and non-removable memory elements such as random-access memory (RAM), read-only memory (ROM), flash, magnetic, optical, universal serial bus (USB) memory devices, and/or other conventional memory elements, such as hard-disk drives.

The programmable electrical circuitry 42 generally provides audio frequency electrical signal gain at a plurality of frequencies in the audio frequency spectrum to compensate for hearing loss. The programmable electrical circuitry 42 may provide gain, or amplify the signal, at the levels and frequencies as depicted in the frequency response graphs of FIG. 1. For example, for a 55-year old man, the programmable electrical circuitry 42 may provide gains (or amplification) of approximately 8 dB at 1000 Hz and approximately 12 dB at 2000 Hz. For a 55-year old woman, the programmable electrical circuitry 42 may provide gains of approximately 8 dB at 1000 Hz and approximately 10 dB at 2000 Hz. However, in general, the programmable electrical circuitry 42 may provide more or less gain at various frequencies than is shown in the graphs of FIG. 1. Thus, the programmable electrical circuitry 42 may provide a variable amount of gain at different frequencies, wherein the number of frequencies and the value of each frequency may be variable as well.

Since the audio frequency response varies from person to person, individual response patterns that provide the appropriate amount of signal gain at various frequencies may be stored for a number of pilots, passengers, or other individuals in the memory element 40, as discussed above. Furthermore, audio frequency response patterns for any age (over 15) of both genders may be interpolated from the graphs of FIG. 1 or from other suitable sources of hearing information. Hence, in certain embodiments, an individual pilot or passenger may enter his or her age and gender into the user interface 32 and get a preprogrammed audio frequency electrical signal gain pattern based on the frequency response graphs of FIG. 1 or any other suitable hearing information source. As mentioned above, the graphs of FIG. 1 are based on a particular sampling of a particular population of people. Plots, like those shown in FIG. 1, with different response patterns may be generated by sampling populations of other individuals or groups of individuals. Accordingly, audio frequency electrical signal gain patterns may be programmed and stored based on those plots, or any other hearing information source, as well.

The pilot may also be able to adjust the signal gain at various frequencies at any time through the user interface 32. The adjustments may be made by moving sliders, rotating knobs, punching numbers into a keypad, or combinations thereof. The changes may also be saved in the memory element 40.

In various embodiments, a profile, that includes an audio frequency response pattern for an individual pilot or passenger, may be stored on a portable storage device, such as the memory element 40, another memory stick or card, a radio frequency identification (RFID) tag, a cell phone, personal data assistant (PDA), or the like, which the pilot or passenger may carry on his person. The profile may be transferred to the hearing loss compensator 22 through the user interface 32 automatically, utilizing wireless data transfer elements, or manually, using USB ports, card readers, or the like.

The programmable electrical circuitry 42 may also comply with the standards and specifications of various government or official aviation-related organizations. For example, the programmable electrical circuitry 42 may comply with the Radio Technical Commission for Aeronautics specification DO-186B, which requires that the audio signal received must be within +/−6 dB of a certain level for the frequencies in the range of the human voice, which may include 100 Hz to 3000 Hz. Thus, the programmable electrical circuitry 42 may provide up to 12 dB of gain for various frequencies between 100 Hz and 3000 Hz. However, the programmable electrical circuitry 42 may provide amplification over any frequency range.

The programmable electrical circuitry 42 may include equalizers, amplifiers, operational amplifiers, low-pass filters, band-pass filters, mixers, combinations thereof, and the like. The circuitry 42 may be formed from analog components, digital components, discrete devices, digital signal processors (DSPs), FPGAs, PLDs, combinations thereof, and the like. Furthermore, the programmable electrical circuitry 42 may include microprocessors, microcontrollers, PICs, and the like that provide electrical signal gain by executing software running on said devices.

In certain embodiments, the hearing loss compensator 22 may receive audio frequency electrical signals from the receiver 18, as shown in FIG. 3. The hearing loss compensator 22 may then apply programmed electrical signal gain at various frequencies and forward hearing loss compensated electrical signals to the sound reproduction device 20. The hearing loss compensator 22 may be a standalone unit that is integrated into or nearby the aircraft cockpit console 12, or the hearing loss compensator 22 may be located in an equipment or electronics bay, or other areas of an aircraft.

In other embodiments, the hearing loss compensator 22 may be integrated into the receiver 18, as shown in FIG. 6. The receiver may then forward hearing loss compensated electrical signals to the sound reproduction device 20. In such embodiments, the hearing loss compensator 22 may share some components with the receiver 18. For example, the user interface 32 and the display 34 may accept user input and display information for the receiver and the hearing loss compensator 22. The hearing loss compensator 22 and the receiver 18 may share processing element 38 functionality as well as other features.

In yet other embodiments, the hearing loss compensator 22 may be integrated in the sound reproduction device 20 as shown in FIG. 7. The sound reproduction device 20 may receive audio frequency electrical signals from the receiver 18. The hearing loss compensator 22 may then apply programmed electrical signal gain at various frequencies and forward hearing loss compensated electrical signals to the speakers 26 of the sound reproduction device 20. The user interface 32 may be simplified as compared with other embodiments. For example, the user interface 32 may be limited to a small keypad, switches, buttons, or knobs. The display 34 may be simplified as well. For example, the display 34 may be very small or may be limited to multi-segment LEDs or single LEDs, or combinations thereof.

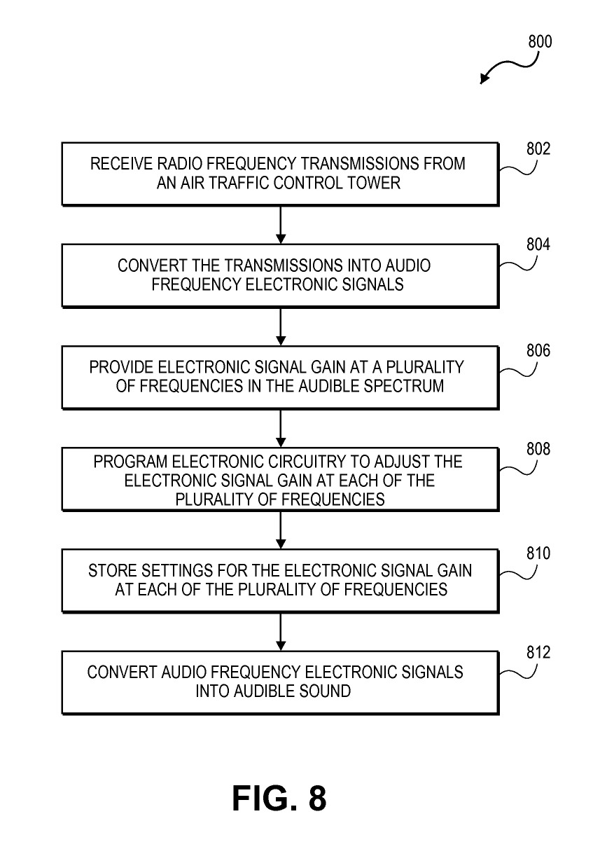

An exemplary method 800 of compensating for hearing loss in an aircraft cockpit 14 environment is illustrated in FIG. 8. The steps as shown in FIG. 8 do not imply a particular order of execution. Some steps may be performed before or concurrently with other steps in contrast to what is shown in the figure. In step 802, radio frequency transmissions are received by an aircraft receiver 18 from a transmitter, such as an air traffic control tower 24, other aircraft 16, FAA stations, or other radio source stations. The receiver 18 converts the transmissions into audio frequency electrical signals in step 804. The audio frequency electrical signals may be forwarded to a hearing loss compensator 22. Electrical signal gain is provided at a plurality of frequencies in the audible spectrum by the hearing loss compensator 22 in step 806. Electrical circuitry 42 in the hearing loss compensator 22 is programmed to adjust the electrical signal gain at each of the plurality of frequencies in step 808. In step 810, settings are stored in a memory element 40 in the hearing loss compensator 22 for the electrical signal gain at each of the plurality of frequencies. The settings may be specific for an individual pilot, passenger, or other individual, groups of pilots, passengers, or individuals, or they may be based on age and gender that are derived from the graphs of FIG. 1 or other sources of hearing information as well. In step 812, the hearing-loss compensated audio frequency electrical signals are converted into audible sound by a sound reproduction device 20 that includes at least one speaker 26.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

What is claimed is:

1. A radio receiving system to compensate for hearing loss, the system comprising:
an aircraft receiver for receiving radio frequency transmissions and converting the transmissions into audio frequency electrical signals;
a sound reproduction device for converting audio frequency electrical signals into audible sound and including at least one speaker; and
a hearing loss compensator, operable for coupling with the aircraft receiver, for providing electrical signal gain at a plurality of frequencies in the audible spectrum to the audio frequency electrical signals, the hearing loss compensator including—
programmable electrical circuitry to adjust the electrical signal gain for at least one of the plurality of frequencies, and
a memory element to store settings for the electrical signal gain for at least one of the plurality of frequencies.

2. The system of claim 1, wherein the hearing loss compensator is integrated with the aircraft receiver.

3. The system of claim 1, wherein the hearing loss compensator is integrated with the sound reproduction device.

4. The system of claim 1, wherein the plurality of frequencies is in the range of approximately 100 Hertz to approximately 3000 Hertz.

5. The system of claim 1, wherein the amount of electrical signal gain at each of the plurality of frequencies provided by the hearing loss compensator varies with an individual's age and gender.

6. The system of claim 5, wherein electrical signal gain settings at each of the plurality of frequencies that are specific to age and gender are stored in the memory element.

7. The system of claim 1, wherein the amount of electrical signal gain at each of the plurality of frequencies provided by the hearing loss compensator is specific to an individual.

8. The system of claim 7, wherein electrical signal gain settings at each of the plurality of frequencies that are specific to an individual are stored in the memory element.

9. The system of claim 1, wherein the amount of electrical signal gain at each of the plurality of frequencies provided by the hearing loss compensator is up to approximately 12 decibels.

10. The system of claim 1, wherein the sound reproduction device is a headset that includes at least one speaker to align with an individual's ear.

11. The system of claim 1, further including a portable storage device operable to removably couple with the hearing loss compensator for storing the settings for the electrical signal gain and transferring the settings for electrical signal gain to the hearing loss compensator.

12. A radio receiving system, comprising:
an aircraft receiver for receiving radio frequency transmissions and converting the transmissions into audio frequency electrical signals;
a headset for converting audio frequency electrical signals into audible sound and including at least one speaker to align with a pilot's ear; and
a hearing loss compensator, coupled with the aircraft receiver, for providing electrical signal gain at a plurality of frequencies in the range of approximately 100 Hertz to approximately 3000 Hertz to the audio frequency electrical signals, the hearing loss compensator including—
programmable electrical circuitry to adjust the electrical signal gain at each of the plurality of frequencies, and
a memory element to store settings for the electrical signal gain at each of the plurality of frequencies;
wherein the amount of electrical signal gain at each of the plurality of frequencies provided by the hearing loss compensator is specific to the individual pilot.

13. The system of claim 12, wherein the amount of electrical signal gain at each of the plurality of frequencies provided by the hearing loss compensator is up to approximately 12 decibels.

14. The system of claim 12, wherein electrical signal gain settings at each of the plurality of frequencies that are specific to the individual pilot are stored in the memory element.

15. The system of claim 14, wherein electrical signal gain settings at each of the plurality of frequencies that are specific to age and gender of the pilot are stored in the memory element.

16. The system of claim 12, wherein the hearing loss compensator further includes a user interface for inputting a pilot's age and gender.

17. The system of claim 16, wherein the user interface can receive the settings for electrical signal gain for an individual pilot.

18. A method for compensating for hearing loss in an aircraft cockpit environment, the method comprising:
a) receiving radio frequency transmissions selected from the group consisting of an air traffic control transmission, an aircraft transmission, a Federal Aviation Administration station transmissions, and combinations thereof;
b) converting the transmissions into audio frequency electrical signals;
c) providing electrical signal gain at a plurality of frequencies in the audible spectrum to the audio frequency electrical signals; and
d) converting audio frequency electrical signals into audible sound for use by a person in the aircraft cockpit environment.

19. The method of claim 18, further including programming electrical circuitry to adjust the electrical signal gain at each of the plurality of frequencies.

20. The method of claim 18, further including storing settings for the electrical signal gain at each of the plurality of frequencies.

21. The method of claim 18, further including storing settings for the electrical signal gain at each of the plurality of frequencies, wherein the settings are specific to an individual pilot.

22. The method of claim 18, further including storing settings for the electrical signal gain at each of the plurality of frequencies, wherein the settings are specific to age and gender of the person.

23. The method of claim 18, wherein the amount of electrical signal gain at each of the plurality of frequencies provided by the hearing loss compensator is specific to an individual pilot.

24. The method of claim 18, wherein the plurality of frequencies is in the range of approximately 100 Hertz to approximately 3000 Hertz.

25. The method of claim 18, wherein the amount of electrical signal gain at each of the plurality of frequencies provided by the hearing loss compensator is up to approximately 12 decibels.
